(19) United States
(12) Patent Application Publication
(10) Pub. No.: US 2011/0151114 A1
(43) Pub. Date: Jun. 23, 2011

(54) COMPOSITE PATTERNING DEVICE AND METHOD FOR REMOVING ELEMENTS FROM HOST SUBSTRATE BY ESTABLISHING CONFORMAL CONTACT BETWEEN DEVICE AND A CONTACT SURFACE

(75) Inventors: Ian Ashdown, West Vancouver (CA); Paul Jungwirth, Burnaby (CA)

(73) Assignee: COOLEDGE LIGHTING, INC., Vancouver (CA)

(21) Appl. No.: 12/968,226

(22) Filed: Dec. 14, 2010

Related U.S. Application Data
(60) Provisional application No. 61/288,035, filed on Dec. 18, 2009.

(51) Int. Cl. B41M 3/00; B05C 9/02

(52) U.S. Cl. 427/146; 118/206

(57) ABSTRACT

A composite patterning device includes a stiff first layer having a Young's modulus in a first range, a flexible second layer having a Young's modulus in a second range, a fluidic layer interposed between the first and second layers and having a Young's modulus in a variable range, and a relief pattern in the second layer. The device can be used for establishing conformal contact between the relief pattern in the second layer and a contact surface of a host substrate with attached elements. Then, a magnetic field is applied to the device so as to increase the Young's modulus of the fluidic layer to be similar to that of second layer after which a force is applied to the contact surface so as to release and remove the elements from the host substrate by withdrawing the device.

This patent application claims the benefit of U.S. provisional application No. 61/288,035, filed Dec. 18, 2009. The disclosure of said provisional application is hereby incorporated herein by reference thereto.

### TECHNICAL FIELD

The subject matter of the present invention is directed generally to the manufacture of transferable semiconductor dice and, more particularly, is concerned with a composite patterning device and a method for removing elements, such as semiconductor dice, from a host substrate by establishing conformal contact between the composite patterning device and a contact surface, including a nonplanar surface.

### BACKGROUND ART

Illumination based on semiconductor light sources, such as light-emitting diodes (LEDs), offers an efficient and long-lived alternative to fluorescent, high-intensity discharge and traditional incandescent lamps. Many LED light sources employ high powered LEDs, which pose thermal management problems and other related problems. Another drawback with state of the art LED devices is a high initial cost.

Small semiconductor dice including those with sizes of 300 um or smaller provide numerous benefits in applications such as broad area lighting, concentrator photovoltaics and electronics. However, devices of this scale cannot be transferred from a source wafer to a target substrate utilizing conventional pick and place technology. One technique that has been considered for employment in transferring devices of this scale is transfer printing. This technique uses composite patterning devices. These devices comprise a plurality of polymer layers each having selected mechanical properties, such as Young's Modulus and flexural rigidity, selected physical dimensions, such as thickness, surface area and relief pattern dimensions, and selected thermal properties, such as coefficients of thermal expansion. These selected properties and dimensions provide high resolution patterning on a variety of substrate surfaces and surface morphologies.

There is therefore a need for an innovation whereby small semiconductor dice can be efficiently and effectively removed from a host substrate.

### SUMMARY OF THE INVENTION

The subject matter of the present invention is directed to such an innovation for establishing conformal contact with a contact surface, such as of a host substrate for removing elements, such as semiconductor dice, from the host substrate. In order to establish such conformal contact with a contact surface of a host substrate, the present invention provides a composite patterning device and a method for removing semiconductor dice from the host substrate wherein the features of the composite patterning device and removal method are enhanced over those of a soft lithography transfer stamp employed heretofore in transfer printing applications.

Thus, in one aspect of the present invention, a composite patterning device for removing elements, such as semiconductor dice, from a contact surface of a host substrate includes a substantially stiff first layer having a Young's modulus in a first range, a substantially flexible second layer having a Young's modulus in a second range, a fluidic layer interposed between the first and second layers and having a Young's modulus in a flexible range, and a relief pattern in the second layer that is capable of establishing conformal contact with a contact surface.

In another aspect of the present invention, a method for removing elements, such as semiconductor dice from a contact surface of a host substrate includes the steps of providing the above-defined composite patterning device, establishing conformal contact between the second layer of the device and a contact surface having attached elements, applying a magnetic field to the device so as to increase the Young's modulus of the fluidic layer to increase stiffness of the second layer, and applying a force to the contact surface in conformal contact with the second layer so as to release the elements from the contact surface. This technique may be used with a planar contact surface, a substantially planar contact surface or a nonplanar contact surface, thus giving the device a wide range of use.

In still another aspect of the present invention, a method for removing elements from a contact surface of a host substrate includes providing a composite patterning device including a substantially stiff first layer having a Young's modulus in a first range and a substantially flexible second layer having a Young's modulus in a variable range that allows the second layer to make conformal contact with a contact surface of a host substrate, establishing contact between the second layer and a contact surface of a host substrate, applying a magnetic field such that the second layer approximately conforms to the profile of the contact surface of the host substrate with attached elements thereof and thus establishes conformal contact therewith, and applying a force to the contact surface in conformal contact with the second layer so as to release the elements from the contact surface of the host substrate. The method further includes interposing a fluidic layer between the first and second layers such that the magnetic field deforms the fluidic layer such that the second layer then approximately conforms to the profile of the contact surface of the host substrate.

### BRIEF DESCRIPTION OF THE DRAWINGS

For clarity, the drawings herein are not necessarily to scale, and have been provided as such in order to illustrate the principles of the subject matter, not to limit the invention.

FIG. 1 is a schematic view of an exemplary embodiment of a composite patterning device in accordance with the present invention.

FIG. 2 is a schematic view of an alternative embodiment of the composite patterning device in accordance with the present invention

FIG. 3 is a schematic view of another alternative embodiment of the composite patterning device in accordance with the present invention.

FIG. 4 is a flow diagram of a sequence of basic steps of a method for removing elements, such as semiconductor dice, from a contact surface of a host substrate, in accordance with the present invention.

### DESCRIPTION OF EMBODIMENTS

The term semiconductor die (plural: dice) includes light-emitting elements, which are any devices that emit electromagnetic radiation within a wavelength regime of interest, for example, visible, infrared or ultraviolet regime, when activated, by applying a potential difference across the device or passing a current through the device. Examples of light-emitting elements include solid-state, organic, polymer, phosphor coated or high-flux light-emitting diodes (LEDs), micro-LEDs, laser diodes or other similar devices as would be readily understood. Without limiting the foregoing, micro-LEDs include LEDs with semiconductor die with lateral dimension 300 micron or smaller. The output radiation of an LED may be visible, such as red, blue or green, or invisible, such as infrared or ultraviolet. An LED may produce radiation of a spread of wavelengths. An LED may comprise a phosphor for converting part of its output from one wavelength to another. An LED may comprise multiple LEDs, each emitting essentially the same or different wavelengths.

While LEDs may be used as examples of transferable elements that can be transferred by the method of the present invention, other semiconductor dice can also be transferred, for example, integrated circuits, photovoltaic cells (for example single junction or multijunction cells for concentrator photovoltaic applications), transistors, photodiodes, laser diodes, resistors, capacitors, non emitting diodes. Semiconductor dice transferred by the disclosed method may be used in electronic devices or in modules that can be incorporated in electronic devices. For example, a luminaire may comprise elements made by the method of the disclosed invention.

Within the purview of the present invention there is recognition that when transferring semiconductor dice from a host substrate to a target substrate it may be necessary to establish conformal contact between a composite patterning device and a nonplanar surface. A prior approach from transfer printing, if adopted, would not allow proper contact between the dice on the host substrate and a nonplanar target substrate. Within the purview of the present invention, a composite patterning device adapted for doing this may include, after substantial modification, a soft lithography transfer stamp as used previously in transfer printing.

The nonplanar surface, with which conformal contact may be established by the composite patterning device of the present invention, may reside on a warped epiwafer, as the host substrate. For example, sapphire substrates can have up to 50 um of bow for a 50-mm diameter epiwafer, while 100-mm diameter epiwafer can exhibit 100 um or more of bow. The semiconductor dice to be removed from the epiwafer may have a thickness of approximately 5 um. It is desirable to have the composite patterning device conform to the bowed epiwafer such that substantially equal force may be applied to the multiplicity of dice in order to effect breakage of their anchors and subsequent attachment to the composite patterning device.

Prior practice in transfer printing involved a soft lithography transfer stamp having a first polymer layer embossed with a three-dimensional relief pattern for conformal contact with the epiwafer and having a low Young's modulus (i.e., flexible), and a second polymer layer having a high Young's modulus (i.e., stiff), wherein a force applied to the second polymer layer is equally transmitted to the first polymer layer. The first polymer layer is a 5- to 10-um thick polydimethylsiloxane (PDMS) material with a Young's modulus of 1 to 10 megapascals (MPa), while the second polymer layer is a 25-um thick polyimide material with a Young's modulus of 1 to 10 gigapascals (GPa). The ability of the first polymer layer to conform to a nonplanar contact surface is therefore limited to at most a few microns such that disadvantageously this prior art soft lithography transfer stamp is substantially incapable of conformally contacting the non-planar contact surface, such as for example, of the warped epiwafer.

Within the purview of the device of the present invention, a composite patterning device is provided which may establish the desired conformal contact with the nonplanar surface of a warped epiwafer by incorporating a fluidic layer whose Young's modulus may be varied by the application of an electric or magnetic field. This fluidic layer is interposed between first and second layers wherein the first layer has a high Young's modulus (i.e., the first layer is stiff) and the second layer has a low Young's modulus (i.e., the second layer is flexible). The second layer has a three-dimensional relief pattern for contact with the epiwafer and, within the further purview of the method of the present invention, may conform to a nonplanar contact surface of epiwafer within a range of tens to hundreds of microns by increasing the Young's modulus of second layer through applying an electric or magnetic field to the fluidic layer prior to applying a force to the second layer that is equally transmitted to the first layer. Additional layers may be added to the second layer to, for example, support the second layer or compensate for differential thermal expansion by means of heating or cooling the second layer.

Suitable fluids forming the fluidic layer may include electrorheological fluids, for example, starch granules suspended in a mixture of mineral oil and lanolin, and magnetorheological fluids, including ferrofluids. Ferrofluids may consist of magnetic nanoparticles such as iron particles, and may have a diameter of 3 to 10 microns suspended in a carrier fluid such as mineral oil, synthetic oil, water or glycol with one or more surfactants selected to prevent gravitational settling and promote particle suspension. Electrorheological or magnetorheological elastomers may also be employed, such as for example iron particles suspended in a silicone rubber such as polydimethylsiloxane (PDMS). In the presence of a magnetic field, the nanoparticles align and develop a yield strength that effectively increases the Young's modulus of the bulk fluid.

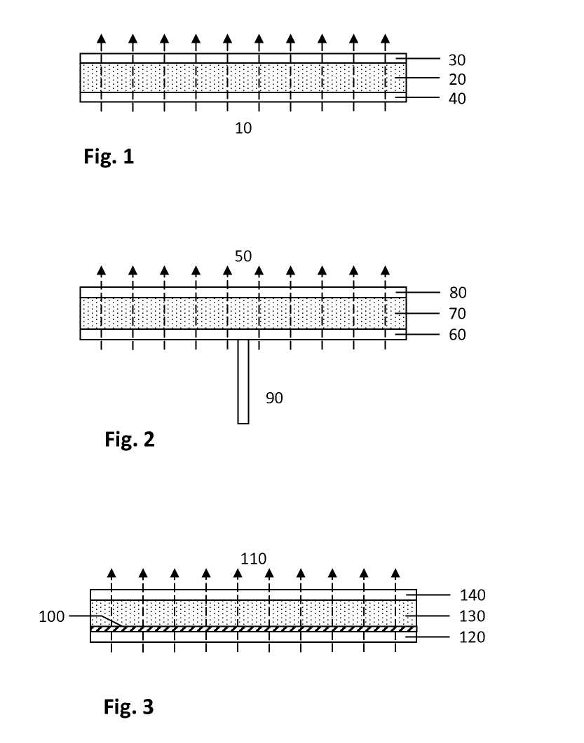

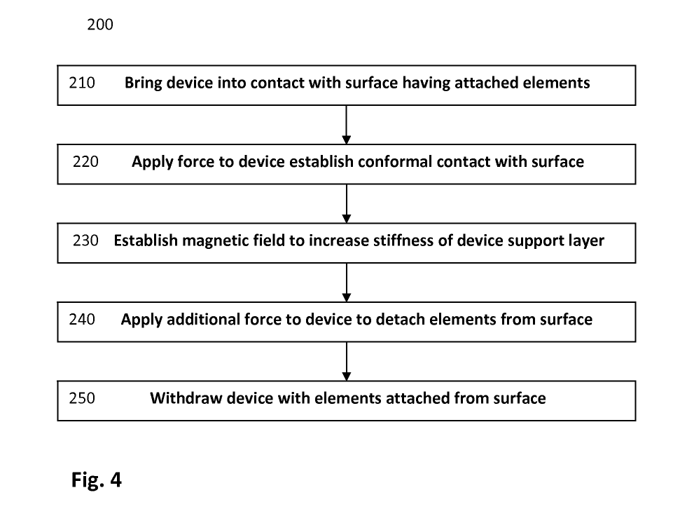

Referring now to FIGS. 1 and 4, there is shown an exemplary embodiment of a composite patterning device 10 (providing a transfer stamp), in accordance with the present invention, which is employed by a method for removing elements, such as semiconductor dice, from a contact surface of a host substrate, also in accordance with the present invention, as depicted in the flow diagram 200 of FIG. 4. As seen in FIG. 1, the composite patterning device 10 includes a variable viscosity fluidic layer 20 interposed between a first support layer 30 with a high Young's modulus, such being within a first range of from 1 to 10 gigapascals (GPa), such that the first support layer 30 is substantially stiff and a second layer 40 with a low Young's modulus, such being within a second range of from 1 to 10 megapascals (MPa), such that the second layer 40 is substantially flexible and a relief pattern embossed on the side of second layer 40 not facing the fluidic layer 20. The first support layer 30 may be any suitable material, including a rigid polymer or a metal plate. The second layer 40 may be any elastomeric material, such as PDMS that is suitable for soft lithographic applications. In step 210 of the flow diagram 200 of FIG. 4, the composite patterning device 10 is brought into initial contact with a contact surface (not shown) of a host substrate (not shown) such that a single point of contact is established between the patterned second layer 40 of the device 10 and the contact surface.

As will be described below, the composite patterning device 10 may be immersed in a magnetic field, as represented by the arrows in FIG. 1, of variable intensity whose direction (indicated by arrows) is perpendicular to the first and second layers 30, 40.

In step 220 of the flow diagram 200, a force is applied to the first support layer 30 of the device 10 that is sufficient to establish conformal contact between the patterned second layer 40 and the contact surface (not shown). The low Young's modulus of the fluidic layer 20 enables the patterned second layer 40 to flex without applying undue force to the contact surface any point. Thus, when the patterned second layer 40 is first brought into contact with the contact surface, the relatively low viscosity of the fluidic layer 20 enables the patterned second layer 40 to conform to the contact surface with minimal force applied to the first support layer 30, thereby minimizing the possibility of damage to the relief pattern of the second layer 40 or to the contact surface.

When the second layer 40 is in conformal contact with the contact surface, in step 230 of the flow diagram 200, a magnetic field, preferably uniform, of sufficient intensity is established and applied to temporarily increase the Young's modulus of the fluidic layer 20 to a desired degree of stiffness, typically ranging from 1 to 10 GPa and thereby increase the stiffness of the second layer 40. The magnetic field may be generated by means not shown such as permanent magnets or by electrical current applied to electromagnets. In step 240 of the flow diagram 200, additional force may then be applied to the first support layer 30 to effect a transfer operation between the second layer 40 and the contact surface wherein the force is evenly transferred via the second layer 40 to the contact surface. Such force may be applied by mechanical movement of the composite patterning device 10 or contact surface, by the energization of a piezoelectric or magnetostrictive actuator (not shown), or by electrostatic attraction. The transfer operation is effected by the application of sufficient force to fracture anchors connecting elements, such as semiconductor dice, to the contact surface of the host substrate. In step 250 of the flow diagram 200, the composite patterning device 10 (providing the transfer stamp) with the attached elements, the semiconductor dice, is then withdrawn from the contact surface in preparation for the next step (not shown) of a transfer operation.

In an alternate embodiment, a three-dimensional profile of the warped epiwafer is obtained using known techniques such as structured light, following which a non-uniform magnetic field is generated by means not shown such as permanent magnets or by electrical current applied to electromagnets and applied, wherein the magnetic field deforms fluidic layer 20 such that second layer 40 approximately conforms to the profile of the warped epiwafer.

In another alternate embodiment, the second layer 40 is an electrorheological or magnetorheological elastomer that is in physical contact with the first support layer 30 without the interposed fluidic layer 20. In this embodiment, the second layer 40 exhibits a variable Young's modulus in response to an electrostatic or magnetic field.

In yet another alternate embodiment shown in FIG. 2, the composite patterning device 50 includes a substantially circular assembly of a variable viscosity fluidic layer 70 interposed between a first support layer 60 with a high Young's modulus and a second polymer layer 80 with a low Young's modulus and a relief pattern embossed on the side of second layer 80 not facing fluidic layer 70 that is brought into contact with the host substrate, wherein the assembly is mounted on a rotating spindle 90.

Prior to bringing the second polymer layer 80 into contact with a contact surface, the assembly and contact surface are continuously rotated to apply centripetal force to fluidic layer 70. Said force causes the fluid to migrate outwards, thereby forming a rotationally symmetric depression in fluidic layer 70 and resultant flexure of the second polymer layer 80 into a substantially parabolic shape. Varying the rotational velocity of spindle 90 enables the second polymer layer 80 to be preformed into a shape that approximates the curvature of the curved contact surface.

If the contact surface exhibits negative rather than positive curvature (that is, the surface is bowed downwards rather than upwards), the assembly shown in FIG. 2 may be inverted such that the second polymer layer 80 sags into a substantially parabolic shape due to gravity. Rotating the assembly again results in the fluid migrating outwards due to centripetal force, thereby lessening the downward sag of the second polymer layer 80.

When the second polymer layer 80 is in conformal contact with the contact surface, magnetic field (as represented by the arrows in FIG. 2) is applied to temporarily increase the Young's modulus of fluidic layer 70. Additional force may then be applied to first support layer 60 to effect a transfer operation between second layer 80 and the contact surface wherein the force is evenly transferred via the second polymer layer 80 to the contact surface.

In yet another embodiment shown in FIG. 3, the composite patterning device 110 has an ultrasonic transducer array 100 interposed between first support layer 120 and fluidic layer 130. When second layer 140 is in conformal contact with the contact surface, a magnetic field (as represented by the arrows) is applied to temporarily increase the Young's modulus of fluidic layer 130. Ultrasonic transducer array 100 is then briefly pulsed to generate a substantially planar supersonic shock wave that traverses the fluidic layer 130 and the second layer 140. The shock wave thereby imparts a momentary force that is evenly transferred via the second layer 140 to the contact surface to fracture the device anchors and thereby release the dice from the epiwafer substrate.

By varying the intensity of the electrical pulses applied to the ultrasonic transducer array elements, it is further possible to vary the magnitude of the momentary force applied to the contact surface via the second polymer layer 140 at different locations across the layer. This permits the removal of specified groups of elements from the contact surface or to compensate for residual differences in the spatial distribution of the force transferred to second polymer layer 140 via fluidic layer 130.

The spatial resolution of the variation in force is dependent upon the spacing of the transducer array elements 100 and the thickness of fluidic layer 130. In another embodiment, the spacing of the transducer array elements is approximately equal to the thickness of the fluidic layer.

In the description herein, embodiments disclosing specific details have been set forth in order to provide a thorough understanding of the invention, and not to provide limitation. However, it will be clear to one having skill in the art that other embodiments according to the present teachings are possible that are within the scope of the invention disclosed. Further, all parameters, dimensions, materials, and configurations described herein are examples only and actual values of such depend on the specific embodiment.

What is claimed is:

1. A composite patterning device for removing elements from a contact surface of a host substrate, comprising:
a substantially stiff first layer having a Young's modulus in a first range;
a substantially flexible second layer having a Young's modulus in a second range;
a fluidic layer interposed between said first and second layers and having a Young's modulus in a flexible range; and
said second layer capable of establishing conformal contact with a contact surface of a host substrate.

2. The device in claim 1 wherein the second layer has a relief pattern capable of establishing conformal contact with the contact surface of a host substrate.

3. The device of claim 1 wherein said first range of the Young's modulus of said first layer is from 1 to 10 gigapascals (GPa).

4. The device of claim 1 wherein said second range of the Young's modulus of said second layer is from 1 to 10 megapascals (MPa).

5. The device of claim 1 wherein said first layer is made of one of a polymer or a metal.

6. The device of claim 1 wherein said second layer is made of a polymer.

7. A method for removing elements from a contact surface of a host substrate, comprising the steps of:
providing a composite patterning device including a fluidic layer having a variable Young's modulus interposed between a substantially stiff first layer having a Young's modulus in a first range and a substantially flexible second layer having a Young's modulus in a second range, the second layer capable of establishing conformal contact with a contact surface of a host substrate;
establishing conformal contact between the second layer and a contact surface of a host substrate having attached elements;
applying a magnetic field to the composite patterning device so as to increase the Young's modulus of the fluidic layer to increase stiffness of the second layer; and
applying a force to the contact surface in conformal contact with the second layer so as to release the elements from the host substrate.

8. The method in claim 7 wherein the second layer has a relief pattern capable of establishing conformal contact with the contact surface of the host substrate.

9. The method of claim 7 wherein said first range of the Young's modulus of said first layer is from 1 to 10 gigapascals (GPa).

10. The method of claim 7 wherein said second range of the Young's modulus of said second layer is from 1 to 10 megapascals (MPa).

11. The method of claim 7 wherein said establishing conformal contact includes rotating the device and the host substrate with said contact surface thereof engaged with the second layer of the device.

12. The method of claim 7 wherein said establishing conformal contact includes applying a first force to the composite patterning device to establish conformal contact with the contact surface.

13. The method of claim 12 wherein the force applied to release the elements from the host substrate is a force in addition to the first force.

14. The method of claim 7 further comprising withdrawing, from the contact surface, the composite patterning device with the elements attached.

15. The method of claim 7 wherein the force applied to release the elements from the host substrate is a shock wave generated by an ultrasonic transducer array interposed between the first and fluidic layers.

16. A method for removing elements from a contact surface of a host substrate, comprising the steps of:
providing a composite patterning device including a substantially stiff first layer having a Young's modulus in a first range and a substantially flexible second layer having a Young's modulus in a variable range that allows the second layer to make conformal contact with a contact surface of a host substrate;
establishing contact between the second layer and a contact surface of a host substrate;
applying a magnetic field such that the second layer approximately conforms to the profile of the contact surface of the host substrate with the attached elements thereon and thus establishes conformal contact therewith; and
applying a force to the contact surface in conformal contact with the second layer so as to release the elements from the contact surface of the host substrate.

17. The method of claim 16 further comprising interposing a fluidic layer between the first and second layers such that the magnetic field deforms the fluidic layer such that the second layer then approximately conforms to the profile of the contact surface of the host substrate.

18. The method of claim 17 further comprising withdrawing, from the contact surface, the composite patterning device with the elements attached.
